(19) United States
(12) Patent Application Publication
(10) Pub. No.: US 2020/0140235 A1
(43) Pub. Date: May 7, 2020

(54) METHOD AND A SYSTEM FOR DETECTING A MALFUNCTION OF AN ELEVATOR SYSTEM

(71) Applicant: Kone Corporation, Helsinki (FI)

(72) Inventors: Ari JUSSILA, Helsinki (FI); Toni HIRVONEN, Helsinki (FI)

(73) Assignee: Kone Corporation, Helsinki (FI)

(21) Appl. No.: 16/598,263

(22) Filed: Oct. 10, 2019

(30) Foreign Application Priority Data
Nov. 6, 2018 (EP) 18204614.4

(51) Int. Cl. B66B 5/00; B66B 1/34; B66B 13/22; B66B 3/00

(52) U.S. Cl. CPC B66B 5/0031; B66B 3/002; B66B 13/22; B66B 1/3492

(57) ABSTRACT

The invention relates to a method for detecting a malfunction of an elevator system. The method comprises: obtaining continuously resistance data representing resistance of an elevator safety chain comprising one or more safety contacts, detecting a temporary change in the obtained resistance data, and generating an indication of a malfunction of the elevator system in response to the detection of the temporary change. The invention relates also to a system implementing at least portions of the method.

### RELATED APPLICATIONS

This application claims priority to European Patent Application No. EP18204614.4 filed on Nov. 6, 2018, the entire contents of which are incorporated herein by reference.

### TECHNICAL FIELD

The invention concerns in general the technical field of elevators. Especially the invention concerns safety of elevators.

### BACKGROUND

Safety plays an important role in the elevators and operational safety of elevator systems has to be secured. Therefore, the elevator system comprises safety components, which monitor the operation of the elevator system and in case of a safety-relevant operational anomaly bring the elevator system to a safe state for example by dropping hoisting machinery brakes and interrupting power supply to the hoisting motor. One such safety-relevant operational anomaly may be for example opening of landing door(s) to an elevator shaft. Thus, the elevator system comprises landing door sensors in the form of door contacts or door lock contacts. These contacts are connected in series to form a safety chain. Also elevator car door(s) are provided with corresponding safety contacts.

When all the contacts of the safety chain are closed, the safety chain forms a closed loop and current may pass through the safety chain, i.e. the safety chain is in a closed state. In the closed state the safety chain enables that an elevator car is allowed to move in the elevator shaft between landings. When at least one of the contacts opens, the safety chain is interrupted, causing dropping of the brakes and interruption of the motor power. When at least one of the contacts is open, the safety chain is in an open state and the current may not pass through the safety chain. In the open state the safety chain prevents the operation of the elevator, i.e., the elevator car is not allowed to move. In case the door or door lock contact breaks or does not fully close due to for instance contamination in the contact, the elevator needs to be taken out of use. Furthermore, a malfunction in an elevator door system may cause an opening of one or more safety contacts.

According to one prior art solution, the condition of the elevator door system, e.g. the condition of the door contacts and door lock contacts, may be manually inspected during a scheduled maintenance. At least one drawback of this prior art solution is that the condition of the elevator door system may be inspected only during the scheduled maintenances, but the condition between the scheduled maintenances cannot be monitored.

According to another prior art solution, for example if the door contacts and/or door lock contacts either have been contaminated too much or are already broken, an alarm may be generated to indicate a malfunction in the door contacts and/or door lock contacts. In that case the operation of the elevator is stopped, and the operation of the elevator is not allowed to be continued before the contaminated or broken contact(s) have been replaced with new contact(s). After the alarm a maintenance personnel may be instructed to replace the contaminated or broken contact(s). Typically, there may be a delay between the alarm and replacement of the contaminated or broken contact(s). Which in turn may cause that the availability of the elevator is reduced, i.e. the time that elevator is in operation is reduced.

Therefore, there is need to develop further solutions in order to improve the availability of the elevator.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method and system for detecting a malfunction of an elevator system. Another objective of the invention is that the method and system for detecting a malfunction of an elevator system improves at least partly the availability of the elevator system.

The objectives of the invention are reached by a method and a system as defined by the respective independent claims.

According to a first aspect, a method for detecting a malfunction of an elevator system is provided, wherein the method comprising: obtaining continuously resistance data representing resistance of an elevator safety chain comprising one or more safety contacts, detecting a temporary change in the obtained resistance data, and generating an indication of a malfunction of the elevator system in response to the detection of the temporary change.

The malfunction of the elevator system may be a misalignment of a landing door, incorrect adjustment of a door coupler, or misalignment of an elevator car.

The resistance data may be obtained by measuring individually resistance of the one or more safety contacts of the elevator safety chain.

The method may further comprise identifying the landing in which the malfunction occurs by identifying the safety contact in which the temporary change of the resistance is detected.

Alternatively or in addition, the method may further comprise: detecting that the obtained resistance of one or more safety contacts meet a predetermined limit, and generating an indication of a wear or contamination of said one or more elevator safety contacts in response to the detection of meeting the predetermined limit.

Alternatively or in addition, the resistance data may be obtained by measuring a total resistance of two or more safety contacts of the elevator safety chain.

The method may further comprise: obtaining position information of the elevator car, and identifying the landing in which the malfunction occurs by determining from the obtained position information the position of the elevator car at the moment of detecting the temporary change in the total resistance.

Alternatively or in addition, the method may further comprise: detecting that the obtained total resistance meets a predetermined limit, and generating an indication of a wear or contamination of at least one safety contact in response to the detection of meeting the predetermined limit.

According to a second aspect, a system for detecting a malfunction of an elevator system is provided, wherein the system comprises: a measurement unit configured to provide continuously resistance data representing resistance of an elevator safety chain comprising one or more safety contacts, and a computing unit configured to: obtain the resistance data from the measurement unit; detect a temporary change in the obtained resistance data; and generate an indication of a malfunction in the elevator system in response to the detection of the temporary change.

The malfunction in the elevator system may be a misalignment of a landing door, incorrect adjustment of a door coupler, or misalignment of an elevator car.

The resistance data may be obtained by measuring individually resistance of the one or more safety contacts of the elevator safety chain.

The computing unit may further be configured to identify the landing in which the malfunction occurs by identifying the safety contact in which the temporary change of the resistance is detected.

Alternatively or in addition, the computing unit may further be configured to: detect that the obtained resistance of one or more safety contacts meet a predetermined limit, and generate an indication of a wear or contamination of said one or more elevator safety contacts in response to the detection of meeting the predetermined limit.

Alternatively or in addition, the obtained resistance data may be obtained by measuring a total resistance of two or more safety contacts of the elevator safety chain.

The computing unit may further be configured to obtain from a sensor unit position information of the elevator car, and the computing unit is further configured to identify the landing in which the malfunction occurs by determining from the obtained position information the position of the elevator car at the moment of detecting the temporary change in the total resistance.

Alternatively or in addition, the computing unit may further be configured to: detect that the obtained total resistance meets a predetermined limit, and generate an indication of a wear or contamination of at least one safety contact in response to the detection of meeting the predetermined limit.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator environment, wherein the system according to the invention may be implemented.

FIG. 2 illustrates schematically an example of a detection system according to the invention.

FIG. 3 illustrates schematically another example of a detection system according to the invention.

FIG. 4 illustrates schematically another example of a detection system according to the invention.

FIG. 5 illustrates schematically an example of a method according to the invention.

FIG. 6 illustrates schematically another example of a method according to the invention.

FIG. 7 illustrates schematically an example of a computing unit according to the invention.

FIG. 8 illustrates schematically an example of a measurement unit according to the invention.

### DESCRIPTION OF THE EXEMPLIFYING EMBODIMENTS

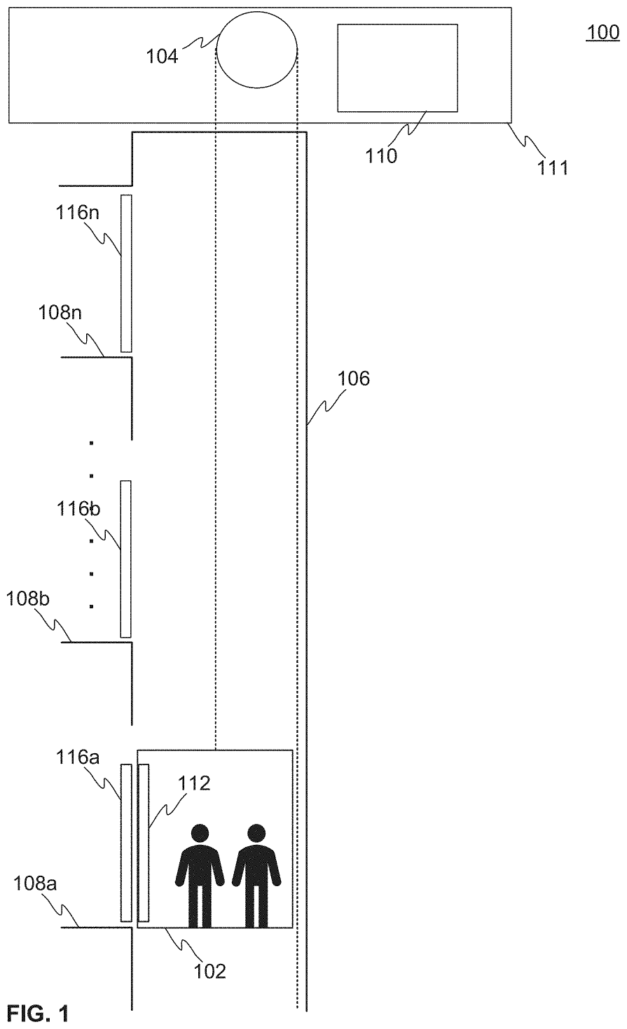

FIG. 1 illustrates schematically an example of an elevator environment 100, wherein the embodiments invention may be implemented as will be described. The elevator environment, e.g. an elevator system 100, may comprise an elevator car 102 and a hoisting machine 104 configured to drive the elevator car 102 along an elevator shaft 106 between landings 108a-108n. An elevator control unit 110 may be configured to control the operation of the elevator system 100. The elevator control unit 110 may reside in a machine room 111 or in the landing.

The elevator car 102 may comprise an elevator car door 112 and a door control unit, e.g. a door operator. Furthermore, each landing 108a-108n may comprise a landing door 116a-116n. The door control unit may be configured to control the operation, e.g. opening and closing, of the elevator car door 112. A door coupler is configured to couple the elevator car door 112 with the landing door 116a-116n to open the landing door in tandem with the elevator car door 112. When the elevator car 102 arrives to a landing 108a-108n, the elevator car door 112 is configured to open and clasp the landing door 116a-116n of landing 108a-108n in question by means of the door coupler in order to open the landing door 116a-116n together with the elevator car door 112. The elevator car door 112, one or more landing doors 116a-116n, and the door control unit may form an elevator door system.

The elevator system 100 may further comprise an elevator safety chain. For sake of clarity the safety chain is not shown in FIG. 1. The safety chain may for example comprise a series connection of landing door safety contacts of different landings and elevator car door safety contacts, i.e. safety switches. The safety contacts may be for example elevator car door contact, landing door contact, door lock contact, etc. The elevator car door contact represents whether the elevator car door is closed or open. The landing door contact represents whether the landing door is closed or open. The door lock contact represents whether the lock of the door is closed or open. The door lock contact may be an elevator car door lock contact or a landing door lock contact.

The safety chain may comprise one or more safety contacts for each door, e.g. one door contact (an elevator car door contact or a landing door contact depending on the door in question) and a door lock contact of said door. If the door is a single opening door, i.e. the door comprises only single door panel, the safety chain may comprise one elevator car door contact, one elevator car door lock contact, one landing door contact for each landing door and one landing door lock contact of each landing door. Alternatively, in case of the single opening door, separate safety circuits may be provided for the elevator car door and for the landing door(s). This means that the safety chain of the elevator car door comprises one elevator car door contact and one door lock contact of the elevator car door and the safety chain of the landing doors comprises one landing door contact for each landing door and one door lock contact of each landing door.

If the door is center opening door, i.e. the door comprises two door panels that meet in the middle and slide open laterally, the safety chain may comprise one elevator car door contact of each elevator door panel, one door lock contact of each elevator door panel, one landing door contact of each landing door panel and one door lock contact of each landing door panel. Alternatively, in case of the center opening door, separate safety chain may be provided for the elevator car door and for the landing doors. This means that the safety chain of the elevator car door comprises one elevator car door contact of each elevator door panel, one door lock contact of each elevator door panel and the safety chain of the landing doors comprises one landing door contact of each landing door panel and one door lock contact of each landing door panel.

The elevator safety chain may comprise one or more separate series connection loops of safety contacts, i.e. one or more safety circuits. The separate loops may be connected at least partially in parallel.

The invention may be implemented in an elevator system comprising a safety chain to which the safety contacts are connected in series. Alternatively, the invention may be implemented in an elevator system comprising a safety chain, wherein all the safety contacts are not directly in series connection. Further, the safety contacts may be connected to a safety controller e.g. with a wire or by means of a data bus.

A detection system 200 for detecting a malfunction of an elevator system according to the invention may be implemented for example to the example elevator system illustrated in FIG. 1. The detection system 200 or detecting a malfunction of an elevator system may comprise a measurement unit 202 and an inspection unit 204.

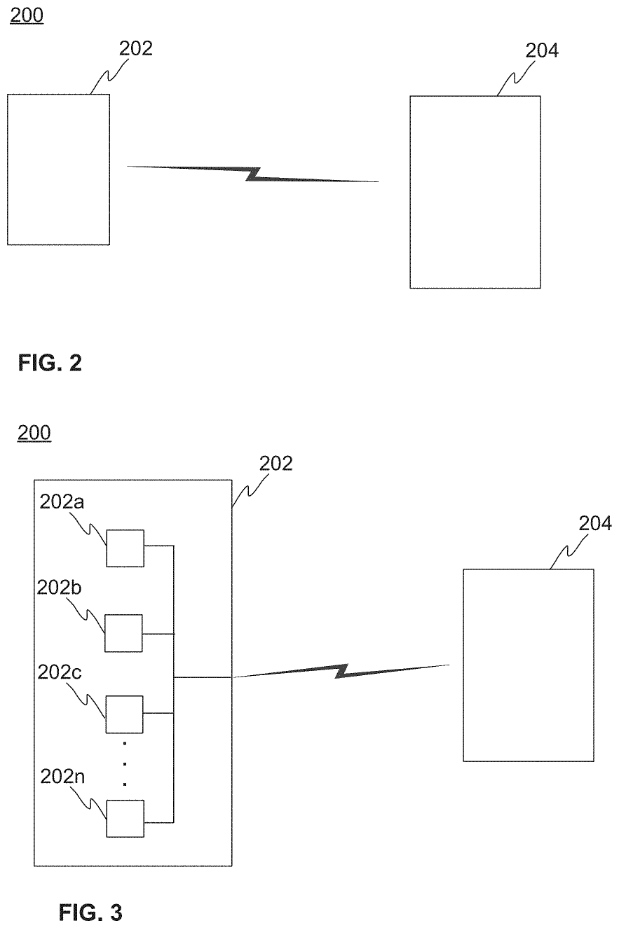

The measurement unit 202 may be configured to measure continuously resistance data representing resistance of an elevator safety chain comprising one or more safety contacts. The resistance data may further comprise a times tamp associated with the measured resistance data in order to define the resistance data as function of time. The measurement unit 202 may be configured to measure the resistance by measuring the voltage over the one or more safety contacts and/or by measuring the current flowing through the one or more safety contacts. According to an embodiment of the invention, the measurement unit 202 may be configured to measure a total resistance of two or more safety contacts of the elevator safety chain in order to provide the resistance data. FIG. 2 illustrates an example of the system 200 according to an embodiment of the invention, wherein elevator system comprises a safety chain comprising one or more safety contacts and the measurement unit 202 is configured to measure the total resistance of two or more safety contacts of the elevator safety chain. The measurement unit 202 may be arranged to a vicinity of the safety chain to be able to measure the resistance data of the safety chain. For example, the measurement unit 202 may be configured to measure the total resistance of the elevator safety chain, i.e. the total resistance of the safety contacts of the safety chain. According to another example, the measurement unit 202 may be configured to measure the total resistance of two or more safety contacts of the elevator safety chain, but not necessary the resistance of all safety contacts of the safety chain. FIG. 3 illustrates an example of the system 200 according to an embodiment of the invention, wherein the measurement unit 202 may be implemented as a distributed measurement unit 202 comprising sub-measurement units 202a-202n. In case the elevator system 100 comprises a plurality of elevator safety circuits, i.e. two or more separate series connection loops of safety contacts, each sub-measurement unit 202a-202n may be configured to measure the total resistance of two or more safety contacts of said separate loops in order to provide the resistance data. In other words, the measurement unit 202 comprises a sub-measurement unit 202a-202n for each safety circuit to measure the total resistance of two or more safety contacts of each safety circuit. According to an embodiment of the invention, the measurement unit 202 may be configured to measure individually the resistance of each of the one or more safety contacts of the elevator safety chain in order to provide the resistance data. In this case the measurement unit 202 may be implemented as a distributed measurement unit 202 comprising sub-measurement units 202a-202n each arranged to measure resistance of one safety contact. In other words, a separated sub-measurement unit 202a-202n may be configured to measure the resistance of individual safety contact. Each sub-measurement unit may be arranged in a vicinity of individual safety contact in order to be capable of measure the resistance of the individual safety contact. For example, the example system illustrated in FIG. 3 may be implemented to measure individually the resistance of each of the one or more safety contacts of the elevator safety chain, but in case the resistance of each individual safety contacts of the safety chain is obtained the measurement unit 202 comprises a sub-measurement unit 202a-202n for each safety contact of the safety chain.

The measurement unit 202 may be configured to communicate with any external units, such as the computing unit 204 or any other units, e.g. the elevator control unit 110. The measurement unit 202 may be configured to provide the obtained resistance data to the computing unit 204. The communication to and from the measurement unit 202 may be arranged in a wireless or in a wired manner so that the communication between the entities may be established as described.

The computing unit 204 may be configured to obtain the resistance data from the measurement unit 202 and to store the obtained resistance data. Furthermore, the computing unit 204 may be configured to monitor the resistance data and in response to a detection of a temporary change in the obtained resistance data, the computing unit 204 may be configured to generate an indication of a malfunction in the elevator system 100.

The malfunction of the elevator system 100 may be for example a misalignment of a landing door 116a-116n, an incorrect adjustment of a door coupler, or a misalignment of an elevator car. For example, in case of an incorrect adjustment of door couplers, e.g. car door couplers and landing door rollers, car door contact and/or landing door contact may open shortly, i.e. temporarily, when the elevator car passes a landing 116a-116n where the incorrect adjustment occurs. The opening of the safety contact in turn causes the temporary change in the obtained resistance data. Alternatively or in addition, in case of a misalignment of landing doors 116a-116n car door contact and/or landing door contact may open shortly and cause the temporary change in the obtained resistance data, when the elevator car passes a landing 116a-116n where the misalignment of landing doors occurs. Alternatively or in addition, a misalignment of the elevator car 102 due to misalignment of an elevator car guide rail caused for example by sagging or swaying of the building in which the elevator system 100 is residing may be detected by detecting the temporary change in the obtained resistance data.

The monitoring of resistance data representing resistance of elevator safety chain enables that short, i.e. temporary, interruptions in the safety chain, e.g. a temporary opening of a safety contact, may be detected as a temporary change in the resistance data. Thus, the present invention provides advantages compared to prior art solutions based on monitoring the condition of the safety chain by obtaining frequency analysis of safety chain current, because from the frequency analysis of safety chain current it is difficult to detect short, i.e. temporary, interruptions in the safety chain.

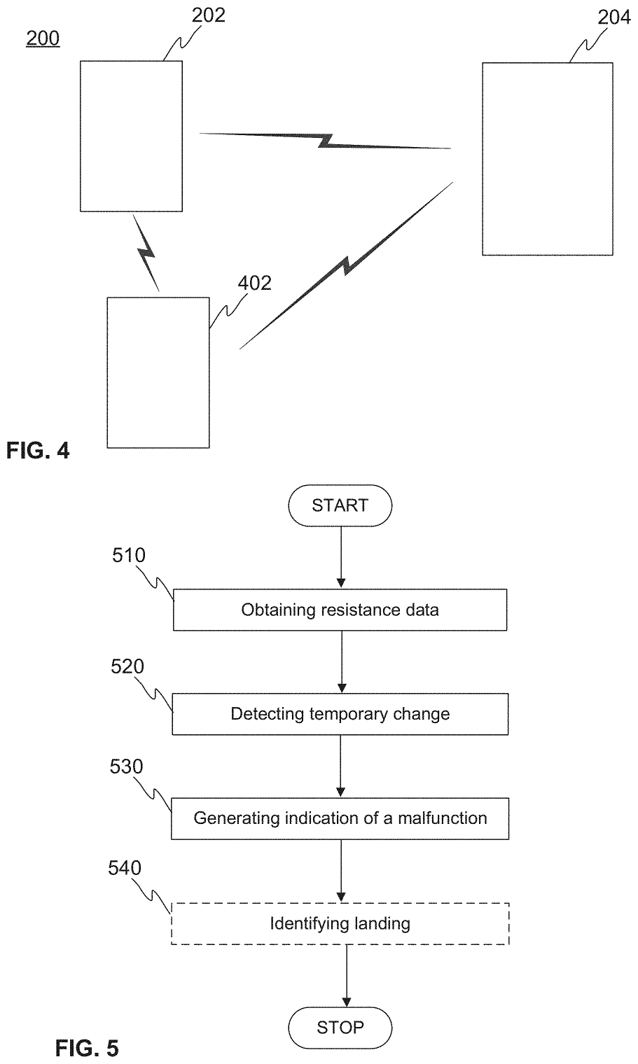

According to an embodiment of the invention, in case the resistance data is obtained by measuring the total resistance of two or more safety contacts of the elevator safety chain, the detection system 200 may further comprise a sensor unit 402 configured to measure position information of the elevator car in order to identify the landing 116a-116n in which the malfunction occurs. The position information of the elevator car may be measured continuously or only in the proximity of the landings 116a-116n. FIG. 4 illustrates schematically an example of the system 200 according to an embodiment of the invention, wherein the system 200 comprises the sensor unit 402 for measuring position information of the elevator. The sensor unit 402 may be arranged for example to the elevator car. The position information may further comprise a time stamp associated with the obtained position information in order to define the position of the elevator car as a function of time. The measurement unit 202 may be configured to obtain the measured position information of the elevator car from the sensor unit 402. The measurement unit 202 may be configured to identify the landing 116a-116n in which the malfunction occurs by determining from the obtained position information the position of the elevator car 202 at the moment of detecting the temporary change in the total resistance. The measurement unit 202 may be further configured to communicate the landing 116a-116n in which the malfunction occurs to the computing unit 204. Alternatively, the computing unit 204 may be configured to obtain the measured position information of the elevator car from the sensor unit 402. The computing unit 204 may be configured to identify the landing 116a-116n in which the malfunction occurs by determining from the obtained position information the position of the elevator car 202 at the moment of detecting the temporary change in the total resistance. For example, the computing unit 204 or the measurement unit 202 may be configured to determine the position of the elevator car 202 at the moment of detecting the temporary change in the total resistance based on the time stamps of the detected temporary change in the total resistance and the obtained position information. In other words, the computing unit 204 or the measurement unit 202 may be configured to find the position of the elevator having corresponding time stamp as the temporary change in the total resistance.

According to an embodiment of the invention, the computing entity 204 may further be configured to generate an indication of a wear or contamination of at least one safety contact in response to a detection that the obtained total resistance meets a predetermined limit. The wear or contamination of the safety contact may cause that the safety contact does not fully close, which in turn causes that the resistance of the safety contact increases. The predetermined limit may be defined so that the wear or contamination of the safety contact is already substantial, but the safety contact is still operating according to requirements, i.e. before the safety contact breaks or the contamination causes that the safety contact does not close at all. This enables that the one or more worn safety contacts may be replaced with new safety contacts already before the worn safety contact breaks or contaminated one or more safety contacts may be cleaned or replaced with new safety contacts before the contaminations causes that the safety contact does not close at all. Thus, it improves the availability of the elevator, i.e. the time that elevator is in operation, because the elevator does not need to be taken out of use because of broken or contaminated safety contact.

According to an embodiment of the invention, when the resistance data is obtained by measuring individually resistance of each of the one or more safety contacts of the elevator safety chain as discussed above, the computing unit 204 may be configured to identify the landing 116a-116n in which the malfunction occurs by identifying the safety contact in which the temporary change of the resistance is detected. For example, the resistance data may further comprise an identifier to identify the contact from which the resistance is measured.

This enables that the computing unit 204 may identify the landing 116a-116n in which the temporary resistance change is detected based on the identifier. For example, if the resistance data comprises individual resistance of the car door contacts and individual resistance of each landing door contact and the computing unit 204 detects a temporary change in the resistance of one landing door contact, the computing unit 204 may identify the landing 116a-116n based on the identifier corresponding to the resistance in which the temporary change is detected.

According to an embodiment of the invention, the computing unit 204 may be further configured to generate an indication of a wear or contamination of said one or more elevator safety contacts in response to the detecting that the obtained resistance of one or more safety contacts meet the predetermined limit. This enables that the wear or contamination of individual safety contact may be monitored and the contaminated or worn safety contact may be identified based on the obtained resistance of said safety contact. This enables that the worn safety contact may be replaced with new safety contact already before the worn safety contact breaks or contaminated safety contact may be cleaned or replaced with new safety contact before the contaminations causes that the safety contact does not close at all. Thus, it improves the availability of the elevator, because the elevator does not need to be taken out of use because of broken or contaminated safety contact.

The computing unit 204 may further be configured to transmit the generated indications, e.g. as a signal, to an elevator service unit that is communicatively coupled to the computing unit 204. The communication between the computing unit 204 and the elevator service unit may be based on one or more known communication technologies, either wired or wireless. Preferably, the generated signal indicating the need for maintenance may be transmitted to the elevator service unit in real time. Alternatively, the generated signal may be transmitted to the elevator service unit periodically, such as once a day. Alternatively, the resistance data may be transmitted to the elevator service unit as a raw data or as processed data containing statistical information, and the elevator service unit may determinate and generate service request based on the data received. The elevator service unit may be for example a service center, service company, remote maintenance server or similar. In response to receiving the indication the elevator service unit may be configured to instruct maintenance personnel to fix a malfunction of the elevator system, for example. The resistance data may be stored as a cumulative data including the whole lifetime of the elevator system and/or separately between each service and maintenance visit to improve and help the planning of the scheduled maintenances. This can mean that malfunction may be determined and maintenance may be provided to the elevator before progress of the malfunction would cause interruption of elevator service.

Above the invention is described relating to the detection system for detecting a malfunction of an elevator system. Next an example of a method for detecting a malfunction of an elevator system according to the invention is described by referring to FIG. 5. FIG. 5 schematically illustrates the invention as a flow chart. The method comprises obtaining 510 continuously resistance data representing resistance of an elevator safety chain comprising one or more elevator door safety contacts as discussed above. According to an embodiment of the invention, the resistance data may be obtained by measuring individually resistance of each of the one or more safety contacts of the elevator safety chain. According to another embodiment of the invention, the resistance data may be obtained by measuring a total resistance of two or more safety contacts of the elevator safety chain. The computing unit may obtain the resistance data from the measurement unit and store the obtained resistance data. The computing unit monitors the obtained resistance data and generates 530 an indication of a malfunction of the elevator system in response to detecting 520 a temporary change in the obtained resistance data as discussed above.

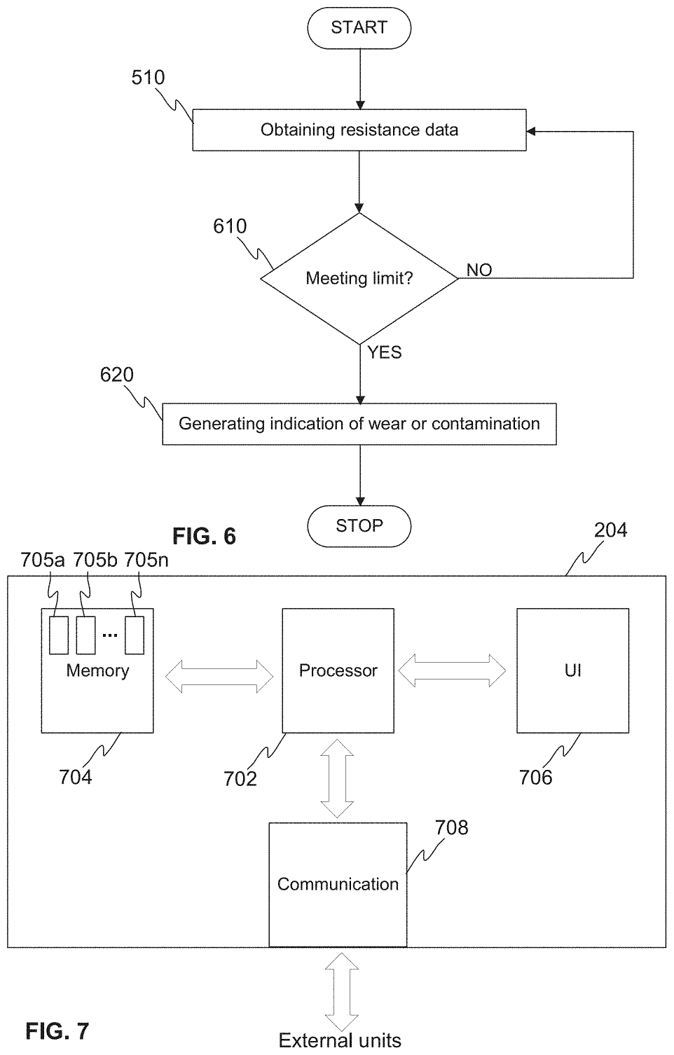

According to an embodiment of the invention, when the resistance data is obtained by measuring the total resistance of two or more safety contacts of the elevator safety chain, the method may further comprise obtaining from the sensor unit position information of the elevator car to identify the landing in which the malfunction occurs. The sensor unit 402 may measure the position information of the elevator car continuously or only in the proximity of the landings 116a-116n. The measurement unit 202 may obtain the measured position information of the elevator car from the sensor unit 402. The measurement unit 202 may identify 540 the landing 116a-116n in which the malfunction occurs by determining from the obtained position information the position of the elevator car 102 at the moment of detecting the temporary change in the total resistance. The measurement unit 202 may further communicate the landing 116a-116n in which the malfunction occurs to the computing unit 204. Alternatively, the computing unit 204 may identify 540 the landing in which the malfunction occurs by determining from the obtained position information the position of the elevator car at the moment of detecting the temporary change in the total resistance as discussed above. According to an embodiment of the invention, the method may further comprise generating 620 an indication of a wear or contamination of at least one safety contact in response to detecting 610 that the obtained total resistance meets a predetermined limit as discussed above and illustrated in FIG. 6. In the example of FIG. 6, the step 610, i.e. detection that the obtained resistance meets the predetermined limit is illustrated after the step 510, i.e. obtaining resistance data, however, the step 610 may also be performed after any of the steps 520-540.

According to one embodiment of the invention, when the resistance data is obtained by measuring individually resistance of each of the one or more safety contacts of the elevator safety chain, the method may further comprise identifying 540 the landing in which the malfunction occurs by identifying the safety contact in which the temporary change of the resistance is detected as discussed above. According to an embodiment of the invention, the method may further comprise generating 620 an indication of a wear or contamination of said one or more elevator safety contacts in response to detecting 610 that the obtained resistance of one or more safety contacts meet the predetermined limit as discussed above and illustrated in FIG. 6.

FIG. 7 schematically illustrates an example of computing unit 204 according to the invention. The computing unit 202 may comprise a processing unit 702 comprising one or more processors, a memory unit 704 comprising one or more memories, a communication unit 708 comprising one or more communication devices, and a user interface (UI) 706. The mentioned elements of may be communicatively coupled to each other with e.g. an internal bus. The one or more processors of the processing unit 702 may be any suitable processor for processing information and control the operation of the computing unit 204, among other tasks. The memory unit 704 may store portions of computer program code 705a-705n and any other data, and the processing unit 702 may cause the computing unit 204 to operate as described by executing at least some portions of the computer program code 705a-705n stored in the memory unit 704. Furthermore, the one or more memories of the memory unit 704 may be volatile or nonvolatile. Moreover, the one or more memories are not limited to a certain type of memory only, but any memory type suitable for storing the described pieces of information may be applied in the context of the invention. The communication unit 708 may be based on at least one known communication technologies, either wired or wireless, in order to exchange pieces of information as described earlier. The communication unit 708 provides an interface for communication with any external unit, such as the measurement unit 202, the elevator control unit 110, the elevator service unit, database and/or any external systems. The user interface 706 may comprise I/O devices, such as buttons, keyboard, touch screen, microphone, loudspeaker, display and so on, for receiving input and outputting information.

The computing unit 204 may be an internal computing unit of the elevator system or an external computing unit. Some non-limiting examples of the internal computing unit 204 may be e.g. a door control unit, an elevator control unit 110, etc. Some non-limiting examples of the external computing unit 204 may e.g. be a remote server, a cloud server, a remote maintenance server, a computing circuit, a network of computing devices. The external unit herein means a unit that locates separate from the elevator system 100. The use of the external computer unit as the computing unit 204 enables that sufficiently large computational resources may be available compared to a use of an internal computing unit. The implementation of the computing unit 204 may be done as a stand-alone entity or as a distributed computing environment between a plurality of stand-alone devices, such as a plurality of servers providing distributed computing resource.

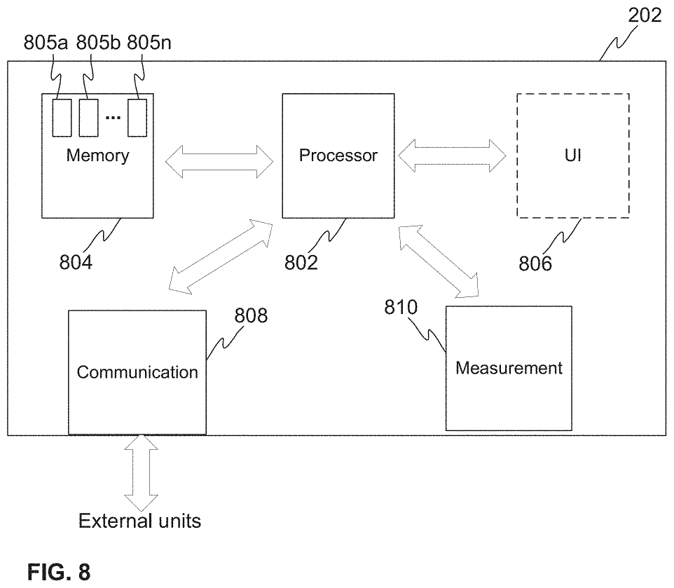

FIG. 8 schematically illustrates an example of measurement unit 202 according to the invention. If the total resistance of the elevator safety chain is measured, the measurement unit 202 may be implemented as an elevator safety control unit, e.g. elevator safety controller, that is used for supplying voltage and current to the safety contacts. Alternatively, the measurement unit 202 may be implemented as an additional measurement unit, i.e. a retrofittable unit, which is not an existing part of the elevator system 100. The measurement unit 202 may comprise a processing unit 802 comprising one or more processors, a memory unit 804 comprising one or more memories, a communication unit 808 comprising one or more communication devices, and possibly a user interface (UI) 806. The measurement unit comprises further measurement related devices 810. The measurement related devices 810 may comprise, but not limited to, one or more instrument for measuring the resistance data. The measurement instruments 810 may comprise for example the sub-measurement units 202a-202n if the measurement unit 202 is implemented as a distributed measurement unit to measure individual resistances of safety contacts as discussed above. Each safety contact may be associated with a sub-measurement unit 202a-202n comprising a measurement amplifier and a microcontroller having an A/D converter for reading output of the measurement amplifier and data communication peripheral device to communicate the resistance value to the computing unit 204. The one or more processors of the processing unit 802 may be any suitable processor for processing information and control the operation of the measurement unit 202, among other tasks. The memory unit 804 may store portions of computer program code 805a-805n and any other data, and the processing unit 802 may cause the measurement unit 202 to operate as described by executing at least some portions of the computer program code 805a-805n stored in the memory unit 804. The communication unit 808 may be based on at least one known communication technologies, either wired or wireless, in order to exchange pieces of information as described earlier. The communication unit 808 provides an interface for communication with any external unit, such as the computing unit 204, the elevator control unit 110, the elevator service unit, database and/or any external systems.

One advantage of the above described invention is that the obtained resistance data may be used to for preventive maintenance, i.e. detect the need for the maintenance because of a malfunction of the elevator system earlier than during the scheduled maintenance visits. Furthermore, the at least some embodiments of the invention enable remote monitoring of the elevator system. Thus, the costs of a site visit may be saved by enabling maintenance person to prepare for maintenance visit with correct spare components, because the need for the maintenance may be defined remotely. Moreover, at least some embodiments of the above described invention improve the availability of the elevator system, i.e. the time when the elevator system is in operation. Thus, ensuring continuous elevator service. Furthermore, at least some embodiments of the invention enable verification of the quality of maintenance or repair after the maintenance or repair operation. For example, if the temporary change in the resistance data is detected for example after adjustment operation of the door coupler, it indicates that the adjustment of the door coupler may be incorrect.

The term “meet” in context of a predetermined limit is used in this patent application to mean that a predefined condition is fulfilled. For example, the predefined condition may be that the predetermined limit is reached and/or exceeded.

The specific examples provided in the description given above should not be construed as limiting the applicability and/or the interpretation of the appended claims. Lists and groups of examples provided in the description given above are not exhaustive unless otherwise explicitly stated.

1. A method for detecting a malfunction of an elevator system, wherein the method comprising:
obtaining continuously resistance data representing resistance of an elevator safety chain comprising one or more safety contacts,
detecting a temporary change in the obtained resistance data, and
generating an indication of a malfunction of the elevator system in response to the detection of the temporary change.

2. The method according to claim 1, wherein the malfunction of the elevator system is a misalignment of a landing door, incorrect adjustment of a door coupler, or misalignment of an elevator car.

3. The method according to claim 1, wherein the resistance data is obtained by measuring individually resistance of the one or more safety contacts of the elevator safety chain.

4. The method according to claim 3, further comprising identifying the landing in which the malfunction occurs by identifying the safety contact in which the temporary change of the resistance is detected.

5. The method according to claim 3, further comprising:
detecting that the obtained resistance of one or more safety contacts meet a predetermined limit, and
generating an indication of a wear or contamination of said one or more elevator safety contacts in response to the detection of meeting the predetermined limit.

6. The method according to claim 1, wherein the resistance data is obtained by measuring a total resistance of two or more safety contacts of the elevator safety chain.

7. The method according to claim 6, further comprising:
obtaining position information of the elevator car, and
identifying the landing in which the malfunction occurs by determining from the obtained position information the position of the elevator car at the moment of detecting the temporary change in the total resistance.

8. The method according to claim 6, further comprising:
detecting that the obtained total resistance meets a predetermined limit, and
generating an indication of a wear or contamination of at least one safety contact in response to the detection of meeting the predetermined limit.

9. A system for detecting a malfunction of an elevator system, wherein the system comprising:
a measurement unit configured to provide continuously resistance data representing resistance of an elevator safety chain comprising one or more safety contacts, and
a computing unit configured to:
obtain the resistance data from the measurement unit,
detect a temporary change in the obtained resistance data, and
generate an indication of a malfunction in the elevator system in response to the detection of the temporary change.

10. The system according to claim 9, wherein the malfunction in the elevator system is a misalignment of a landing door, incorrect adjustment of a door coupler, or misalignment of an elevator car.

11. The system according to claim 9, wherein the resistance data is obtained by measuring individually resistance of the one or more safety contacts of the elevator safety chain.

12. The system according to claim 11, wherein the computing unit is further configured to identify the landing in which the malfunction occurs by identifying the safety contact in which the temporary change of the resistance is detected.

13. The system according to claim 11, the computing unit is further configured to:
detect that the obtained resistance of one or more safety contacts meet a predetermined limit, and
generate an indication of a wear or contamination of said one or more elevator safety contacts in response to the detection of meeting the predetermined limit.

14. The system according to claim 9, wherein the obtained resistance data is obtained by measuring a total resistance of two or more safety contacts of the elevator safety chain.

15. The system according to claim 14, the computing unit or the measurement unit is further configured to obtain from a sensor unit position information of the elevator car, and the computing unit or the measurement unit is further configured to identify the landing in which the malfunction occurs by determining from the obtained position information the position of the elevator car at the moment of detecting the temporary change in the total resistance.

16. The system according to claim 14, wherein the computing unit is further configured to:
detect that the obtained total resistance meets a predetermined limit, and
generate an indication of a wear or contamination of at least one safety contact in response to the detection of meeting the predetermined limit.
